(19) United States
(12) Patent Application Publication
(10) Pub. No.: US 2009/0120266 A1
(43) Pub. Date: May 14, 2009

(54) Apparatus For Converting Fretless Fingerboard To Fretted Fingerboard On A Musical Instrument

(76) Inventor: Peter Stoney, Windsor (CA)

Correspondence Address: HODGSON RUSS LLP;THE GUARANTY BUILDING, 140 PEARL STREET, SUITE 100, BUFFALO, NY, 14202-4040, US

(21) Appl. No.: 11/939,624

(22) Filed: Nov. 14, 2007

(51) Int. Cl. G10D 1/02

(52) U.S. Cl. 84/314 R

(57) ABSTRACT

An apparatus for converting a stringed musical instrument with a non fretted fingerboard board to a fretted fingerboard in which the instrument comprises a neck, a plurality of strings extending across said neck, a fingerboard on said neck having a front surface which is selectively engagable by depression of said strings for selective generation of desired sounds when said strings are physically engaged and vibrated, a sound generating chamber or sound pick up area for generating and/or amplifying sounds responsive to vibration of said strings wherein said apparatus comprises an elongate strip shaped to fit over said front surface of the finger board, said strip having a front side including a plurality of raised frets extending perpendicular to the length of the strings and the rear side including adhesive material and being attachable to the front surface of the fingerboard. The strip comprises a bottom plastic layer and each fret is formed from a filament positioned on upon the front surface of said bottom layer at desired spaced intervals along the strip, and a transparent plastic film layer is positioned over said filaments to secure them in place. Alternately, filaments may be embedded in the strip.

### FIELD OF THE INVENTION

This invention relates to an improvement in stringed musical instruments and, more particularly, to stringed musical instruments of the type having an elongate neck and a body and which generate sounds in response to vibration of strings extending across the body. In particular the invention relates to an apparatus which allows the replacement of a fretless fingerboard surface with a fretted fingerboard surface.

### BACKGROUND OF THE INVENTION

Stringed instruments without frets are often referred to as “fretless” instruments. The length of the string for sound production is determined by the distance between the point at which the player keeps the string pressed against the fingerboard and the bridge of the instrument (positioned over a sound generating chamber and/or electrical sound pick up). In absence of the fret, there is often a desirable quality to the sound as is typical in string instruments such a violin or cello or the like.

In some situations, such as to assist in educating a beginner string instrument player on proper finger placement, and to alter the sound of emanating from a stringed instrument, it is desirable to use a musical instrument with a fretted fingerboard instead of a fretless fingerboard. Many prior art documents disclose complicated systems to replace the fingerboard or portions thereof of stringed instruments. If any changes are made to the fingerboard, even by a small amount, the musical quality of the instrument is altered and frequently to the detriment of the generated sounds. Moreover, it is critical in connection with any stringed musical instrument to insure that any substituted portion of the fingerboard is tightly mounted onto the neck of the musical instrument to ensure there are no undesired generated vibrations between the fingerboard and the neck of the instrument thus resulting in a negative impact on the quality of the sound produced. Given the complicated nature of many of the adjustable fingerboards known in the art, and the detrimental impact of many on instrument sound quality, there is no known convenient and sound neutral means for altering an instrument between fretted and unfretted. Thus, the average musician must use two instruments, one containing frets and one without frets or will have to use a complex apparatus requiring significant adjustment to the instrument to ensure there is no undesired detrimental effect on sound quality.

There is a need for an improved apparatus for altering an instrument between a fretted fingerboard and fretless option.

### SUMMARY OF THE INVENTION

It is an object of the present invention to provide a stringed musical instrument in which the instrument may be easily converted from a fretless to a fretted instrument without impacting on the sound quality of the instrument.

In accordance with an aspect of the invention, there is provided an apparatus for converting a stringed musical instrument with a non fretted fingerboard board to a fretted fingerboard, said instrument comprising: a) a neck; b) a plurality of strings extending across said neck; c) a fingerboard on said neck having a front surface which is selectively engagable by depression of said strings for selective generation of desired sounds when said strings are vibrated; d) a sound generating chamber or sound pick up area for generating and/or amplifying sounds responsive to vibration of said strings wherein said apparatus comprises an elongate strip shaped to fit over a portion of said front surface of the finger board, said strip including a plurality of raised frets extending perpendicular to the length of the strings and a rear side including adhesive material and being attachable to the front surface of the fingerboard. The strip may cover some or all the front surface of the fingerboard. The adhesive may extend over the entirety of the rear surface of the strip. The strip may comprise plastic, metal or wood.

In accordance with an aspect of the invention the strip comprises a bottom plastic layer, including a rear side, and a front surface and each fret is formed from a filament positioned upon the front surface of said bottom layer at desired spaced intervals along the strip, and a transparent plastic film layer, such as transparent tape is positioned over said filaments to secure them in place. Alternately, filaments may be embedded in the strip.

It is to be understood that this following detailed description and the accompanying drawings are set forth only for purposes of illustrating the general principles of the invention. Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinbelow.

### BRIEF DESCRIPTION OF THE DRAWINGS

Reference to an example embodiment of the invention will now be made in the accompanying drawings in which:

FIG. 1 is a perspective view of a stringed musical instrument prior to insertion of a fingerboard strip in accordance with the invention positioned on the fingerboard;

FIG. 1A is a perspective view of a stringed musical instrument with a fingerboard strip in accordance with the invention positioned on the fingerboard;

FIG. 2 is top view of a preferred embodiment of a strip on the invention; and

FIG. 3 is a section view of the strip taken along line A-A in FIG. 2, in accordance with an aspect of the invention.

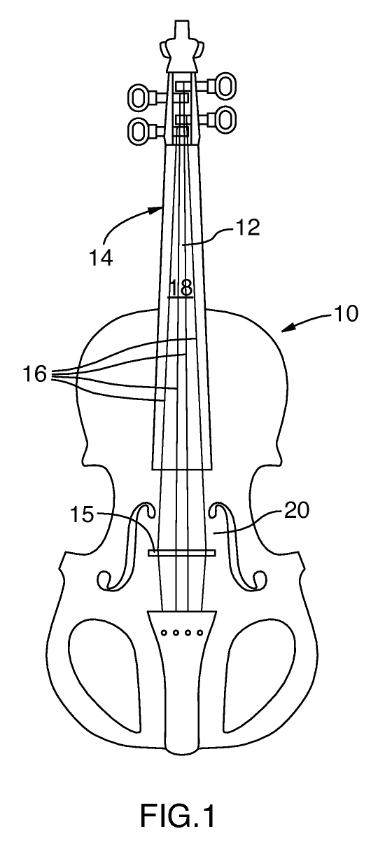

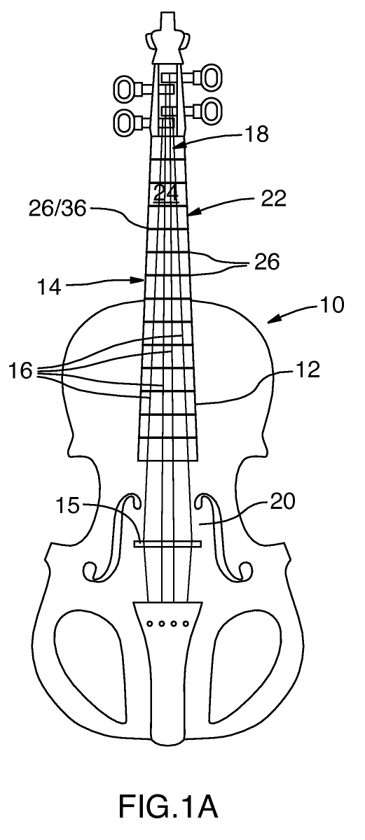

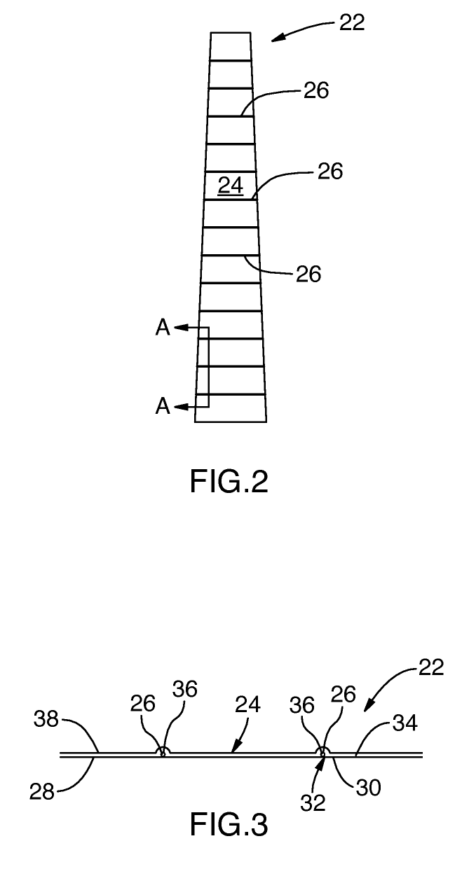

### DETAILED DESCRIPTION OF AN EXAMPLE EMBODIMENT OF THE INVENTION

As shown in the Figures, there is illustrated an example embodiment of an apparatus for converting a stringed musical instrument 10 with a non fretted fingerboard board 12 to a fretted fingerboard. The instrument shown is a violin 10. It should be understood that the apparatus could be used with any stringed instrument, whether acoustical or electric, such as a guitar or base guitar. The instrument comprises a neck 14 a plurality of strings 16 extending across the neck 14 to a bridge 15. The fingerboard 12 on the neck has a front surface 18 which is selectively engagable by depression of said strings for selective generation of desired sounds when said strings are physically engaged and vibrated, such as with a bow for stringed instruments, such as violins, cellos, or plucked by a pic or fingers such a by a guitar. The instrument includes a sound generating chamber 20 (for acoustic instruments) below the bridge 15 and/or a sound pick up area (for electrical instruments) for generating and/or amplifying sounds responsive to vibration of said strings. The example embodiment of the invention comprises an elongate strip 22 which is cut to fit over said front surface 18 of the finger board. The strip has a front side 24 including a plurality of regularly raised frets 26 extending perpendicularly to the length of the strings 16.

The rear side 28 of the strip includes adhesive material and being attachable to the front surface of the fingerboard. In the example embodiment, adhesive material extends over the entirety of the rear surface of the strip to ensure a complete bond to the surface of the fingerboard. To attach the strip to the fingerboard, the strings are loosened sufficiently or removed so as to expose the front surface 18 of the fingerboard. Once the strip is attached, the strings can be retightened and tuned as desired. Complete bonding of the strip to the fingerboard is desired to ensure that the strip does not vibrate against the board upon creation of sound from string vibration. The strip must be of a thickness that ensures that it does not impede the free vibration of strings extending thereacross when the strip is positioned on the fingerboard.

In the example embodiment, the adhesive is pressure sensitive adhesive which will allow for detachment and reattachment of the strip to the fingerboard without leaving adhesive residue.

For purposes herein, pressure sensitive adhesive refers to any adhesives which in dry form (solvent/water free) are aggressively and permanently tacky at room temperature and that firmly adhere to a variety of dissimilar surfaces upon mere contact without the need of more than finger or hand pressure. The preferred pressure sensitive adhesive requires no activation by water, solvent, or heat in order to exert a strong adhesive holding force toward such materials as paper, plastic, glass, wood, cement, and metal. It has sufficient cohesive holding power and elastic nature so that, despite their aggressive tackiness, they can be handled with the fingers and removed from smooth surfaces without leaving a residue. Any such pressure sensitive adhesive could be used for purposes herein. Furthermore, suitable commercially available sheets, such as commercial shelving paper, having an adhesively coated side could be utilized to form the bottom layer of the strip.

For certain purposes in accordance with an aspect of the invention a more permanent bonding adhesive may be used and is contemplated by the invention.

In the preferred embodiment, the strip 22 comprises a bottom plastic layer 30, such as commercially available shelving liner. The bottom layer includes a rear side 32 and a front surface 34. Each fret is formed from a filament 36 positioned on upon the front surface of said bottom layer at desired spaced intervals along the strip. A transparent plastic tape layer 38 is positioned over said filaments to secure them in place. In the example embodiment, the filament is a monofilament made of nylon or metal. It should be understood that the fret could be formed of any suitable material or article or the like such as a strip of metal or plastic or wood or other suitably shaped and rigid material.

Alternately, it should be understood that the frets may be comprised of filaments, monofilaments or such strips embedded directly in a unitary strip.

It should be further understood that the strip may comprise plastic, wood or metallic materials.

It should be understood that many changes, modifications, variations and other uses and applications will become apparent to those skilled in the art after considering the specification and the accompanying drawings. Therefore, any and all such changes, modifications, variations and other uses and applications which do not depart from the spirit and the scope of the invention are deemed to be covered by the invention.

1. An apparatus for converting a stringed musical instrument with a non fretted fingerboard board to a fretted fingerboard, said instrument comprising: a) a neck; b) a plurality of strings extending across said neck; c) a fingerboard on said neck having a front surface which is selectively engagable by depression of said strings for selective generation of desired sounds when said strings are vibrated; d) a sound generating chamber or sound pick up area for generating and/or amplifying sounds responsive to vibration of said strings wherein said apparatus comprises an elongate strip shaped to fit over a portion of said front surface of the finger board, said strip including a plurality of raised frets extending perpendicular to the length of the strings and a rear side including adhesive material and being attachable to the front surface of the fingerboard.

2. An apparatus as recited in claim 1 wherein the adhesive extends over the entirety of the rear side of the strip.

3. An apparatus as recited in claim 1 wherein said strip comprises a plastic sheet.

4. An apparatus as recited in claim 1 wherein the strip comprises a bottom plastic layer, including said rear side, and a front surface, each said fret is formed from a filament positioned on upon the front surface of said bottom layer at desired spaced intervals along the strip, and a transparent plastic film layer is positioned over said bottom plastic layer and said filaments to secure them in place.

5. An apparatus as recited in claim 4 wherein said filament is a monofilament.

6. An apparatus as recited in claim 1 wherein said frets are comprised of filaments embedded in said strip.

7. An apparatus as recited in claim 1 wherein the strip comprises plastic, wood or metallic materials.

8. An apparatus as recited in claim 5 wherein said monofilaments are comprised of nylon or metal.

9. An apparatus as recited in claim 6 wherein said filaments comprise monofilaments of nylon or metal.

10. An apparatus as recited in claim 1 wherein said adhesive is pressure sensitive adhesive.

11. An apparatus as recited in claim 10 wherein said strip is selectively detachable and readherable to said fingerboard with out leaving any adhesive residue on the fingerboard upon removal of the strip.

12. Apparatus as recited in claim 4 wherein said transparent plastic layer is transparent tape, adhered over bottom plastic layer and said monofilaments to secure them in place.
